(19) United States
(12) Patent Application Publication
(10) Pub. No.: US 2021/0173687 A1
(43) Pub. Date: Jun. 10, 2021

(54) Overlap Customer Planned Activity to Migrate a Virtual Machine

(71) Applicant: Microsoft Technology Licensing, LLC, Redmond, WA (US)

(72) Inventors: Naresh Kumar BADE, Hyderabad (IN); Shiva Shankar JAYANTHI, Khammam (IN); Xu YANG, Bellevue, WA (US); Deep Kiran SHROTI, Bhopal (IN); Ajay MANI, Redmond, WA (US)

(73) Assignee: Microsoft Technology Licensing, LLC, Redmond, WA (US)

(21) Appl. No.: 16/708,336

(22) Filed: Dec. 9, 2019

(51) Int. Cl. G06F 9/455; G06F 9/48

(52) U.S. Cl. CPC G06F 9/45558; G06F 2009/45575; G06F 2009/4557; G06F 9/4856

(57) ABSTRACT

Described herein is a system and method for overlapping migration to another host node with a customer request to stop or reboot a virtual machine. A customer request is intercepted. Determination whether or not migration of the virtual machine on the source host node is capable of being performed. When the migration of the virtual machine on the source host node is capable of being performed, the virtual machine is stopped on the source host node, and, the virtual machine is migrated to an updated host node. When the customer request is a stop of the virtual machine, the virtual machine is stopped on the updated host node. When the customer request is a reboot of the virtual machine, the virtual machine is rebooted on the updated host node.

### BACKGROUND

Servicing an underlying node hosting virtual machine(s) can cause unexpected downtime for a customer. For example, multiple unexpected reboots related to servicing an underlying host can have a significant negative impact to the customer.

### SUMMARY

Described herein is a system for overlapping migration with customer initiated downtime (e.g., stop and/or reboot) from an update pending host to another already updated host node, comprising: a computer comprising a processor and a memory having computer-executable instructions stored thereupon which, when executed by the processor, cause the computer to: receive a customer request regarding a virtual machine on a source host node; intercept the customer request; whether or not migration of the virtual machine on the source host node is capable of being performed; when the migration of the virtual machine on the source host node is capable of being performed: stop the virtual machine on the source host node; and migrate the virtual machine to an updated host node.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for overlapping migration to another host node.

FIG. 2 is a flow chart that illustrates a method of overlapping migration to another host node during a shutdown.

FIG. 3 is a flow chart that illustrates a method of overlapping migration to another host node during a reboot.

FIG. 4 is a functional block diagram that illustrates an exemplary computing system.

### DETAILED DESCRIPTION

Various technologies pertaining to overlapping customer planned activity to facilitate migration of a virtual machine are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding overlapping customer planned activity to facilitate migration of a virtual machine. What follows are one or more exemplary systems and methods.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

Servicing a physical host node of virtual machine(s) (VMs) can cause unexpected downtime for a customer because when the underlying host node goes down during update all the VMs hosted on the node also experience downtime. That is, in some scenarios, migrating the host node to an updated host node can impact the customer by causing multiple un-expected reboots (e.g., annually).

The system and method described herein leverages a customer initiated planned activity to trigger migration of a VM from a host node to an updated host node. In this manner, impact of the servicing of the node can be significantly minimized to the customer. The updated node can be co-experienced with the customer's planned activity.

The customer initiated planned activity can include a stop, a portal trigger reboot, and/or an in-VM reboot. By leveraging on to the customer initiated planned activity, migration from the host node to another updated host node can significantly reduce impact to the customer. In this way, the migration to an updated node can occur at a time chosen by the customer instead of a time chosen which may not be acceptable to the customer.

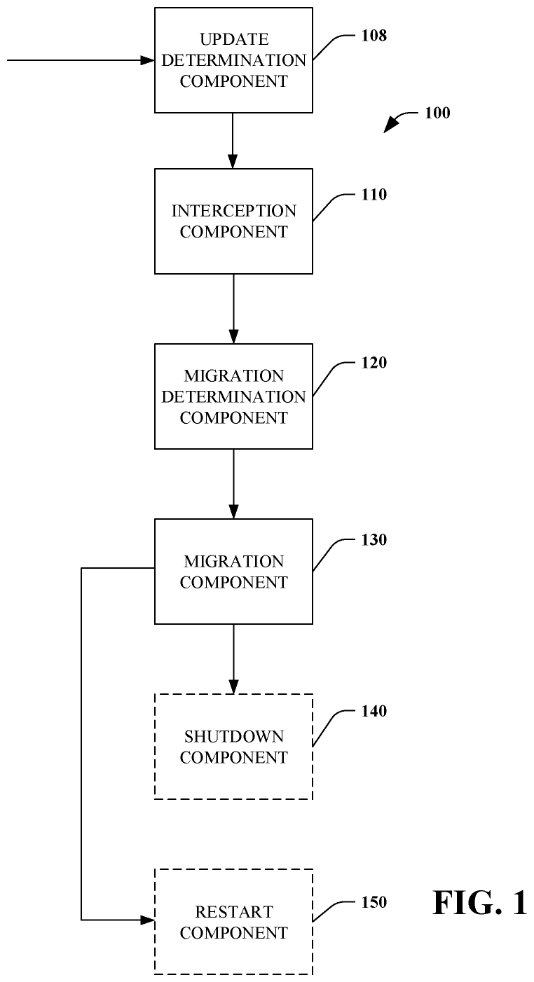

Referring to FIG. 1, a system for overlapping migration to another host node 100 is illustrated. By overlapping migration with a customer initiated planned activity, migration from a host node to an updated host node can significantly reduce impact to the customer. Instead of planned host maintenance, a customer can have a planned activity(ies) which requires the VM to be shut down or rebooted. The system 100 can leverage the customer planned activity to perform planned host maintenance and avoid or minimize unexpected customer downtime.

The system 100 can perform “stop-migration” in which a VM is migrated in a stopped state from a source host node to an updated host node. Hence, in case of planned maintenance, the VM is stopped and then migrated from the source host node to another updated host node when the customer does a destructive operation on the VM (e.g., customer shutdown and/or reboot).

The update determination component 108 can determine that an update for the source host node is currently available. That is, that an updated host node is ready for the VM to be mitigated from the source host node to the updated host node. The system 100 includes an interception component 110 that intercepts a customer request to reboot and/or shutdown of a virtual machine on a source host node. The system 100 further includes a migration determination component 120 that checks/determines whether or not migration of the virtual machine on the source host is capable of being performed.

The system 100 includes a migration component 130 that, when the migration of the virtual machine of the source host is capable of being performed, intercepts the stopping of the virtual machine on the source host. The migration component 130 then migrates the virtual machine of the source node to an updated host node where the stopping can resume.

In some embodiments, the migration component 130 includes moving a VM configuration from the source node to the updated host node. In some embodiments, the migration component 130 includes moving VM setting(s) from the source node to the updated host node. In some embodiments, a virtual filtering platform (VFP) state is restored (e.g., state regarding the source node is restored to the updated host node).

The system 100 optionally includes a shutdown component 140 that, when the customer request comprises a shutdown, the virtual machine on the updated host node is stopped. The system 100, optionally, includes a restart component 150 that, when the customer request comprises a reboot, the virtual machine is started on the updated host node, as discussed below.

The system 100 can leverage platform maintenance in response to the customer triggered reboot. In this manner, unexpected platform maintenance can be overcome by performing the platform maintenance (e.g., migration of VM from a source host node to an updated host node) in addition to the customer initiated VM reboot.

In some embodiments, the customer initiated VM reboot can include a portal triggered reboot. A portal triggered reboot is initiated to reboot a VM from a cloud-based service portal. Conventionally, in case of normal portal triggered reboot, the VM is stopped and then restart on the same host node.

The system 100 can perform migration of a virtual machine from a host node to an updated host node. Thus, the stop is intercepted and the VM is stop-migrated on to the updated host node. In this manner, the system 100 can convert the portal triggered reboot into a stop-migrate-start.

When the portal triggered reboot is initiated by the customer for a VM, the interception component 110 can intercept the reboot. The migration determination component 120 can check/determine whether or not migration of the virtual machine on the source host is capable of being performed. In some embodiments, the migration determination component 120 can utilize a Node Service, which is a goal-state driving engine residing on the host node. The migration determination component 120 then catches the VM in stopping state and calls a Fabric-Controller for a preliminary migration check.

If the preliminary migration check succeeds, the migration component 130 can put the VM in a stopped state. Further operation(s) on the VM are blocked on the source host node and a stop migration request is raised by the Node Service for the VM. The Fabric Controller, on receiving this request, triggers a stop-migration for the VM from the source host node to an updated destination host node. This provides an improved customer experience as compared to that of an unplanned reboot.

In some embodiments, the customer can initiate reboot using a VM restart operation from inside the VM (“In-VM”). Normally, the VM undergoes a guest-initiated reboot operation on the same host node (e.g., when migration of the source host node to the updated host node is not performed). However, in order to allow the system 100 to migrate from the source host node to the updated host node, the guest-initiated reboot can be broken down into two operations: (1) stop; and (2) start.

The system 100 can intercept the stop in order to stop and migrate the source host node to the update host node (e.g., the VM is stopped and then migrated on to an updated host node). That is, the In-VM reboot is converted to “stop-migrate-start”.

In some embodiments, a customer can opt-in to allowing migration using a parameter for In-VM reboot. The parameter can allow migration from the source node onto the updated host node. For example, a “TurnOffOnGuestRestart” parameter can be utilized for the VM. This parameter can be passed down to a hypervisor. When In-VM reboot is triggered by the customer, the interception component 110 can intercept the reboot request. The interception component 110 can use the hypervisor to catch the internal reboot of the VM and put the VM in stopped state. Then, the migration determination component 120 can use the Node Service to intercept this stopped VM state and call the fabric controller for preliminary migration check. This allows the migration determination component 120 to determine if migration is allowed at this current time.

If the preliminary migration check succeeds, further operations on the VM are blocked on the source host node and a stop-migration request is raised by the Node Service to the Fabric Controller for the VM. The Fabric Controller receives this request and triggers stop-migration for the VM from the source host node to an updated host node.

In some embodiments, due to a migration operation, the customer observed downtime can be more than the normal reboot downtime. However, the extra downtime may be satisfactory since it avoids a potential unexpected reboot (e.g., at an improper and/or unoptimistic time).

The stop-migration to leverage customer planned maintenance activity(ies) (e.g., stop and/or reboot) to perform platform update(s) such as host operating system update can significantly improve a customer's experience. That is, without leveraging customer planned maintenance activity(ies), the customer experiences downtime that is unwanted and/or at an undesirous time for updating a host operating system.

In some embodiments, by taking advantage of a shutdown or reboot by a customer, a platform update can be performed during the downtime. In this manner, unexpected impact experience by the customer is reduced and thus the unexpected reboots observed by the customer (e.g., annually) is also reduced.

In some embodiments, there may be VMs where live migration is not applicable; however, these VMs can still be stop-migrated from the unallocated host nodes. Otherwise, the service can heal after a period of time (e.g., a week) causing customer downtime. In some embodiments, stop migration can be used in cluster de-fragmentation and/or decommissioning to migrate virtual machine(s) VMs where live migration is not applicable. This is because stop-migration works with various hardware and/or virtual machine types.

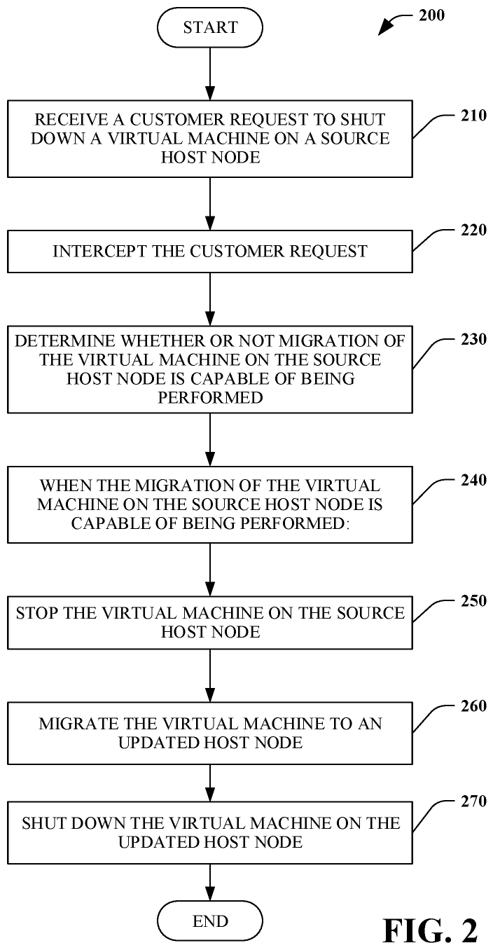

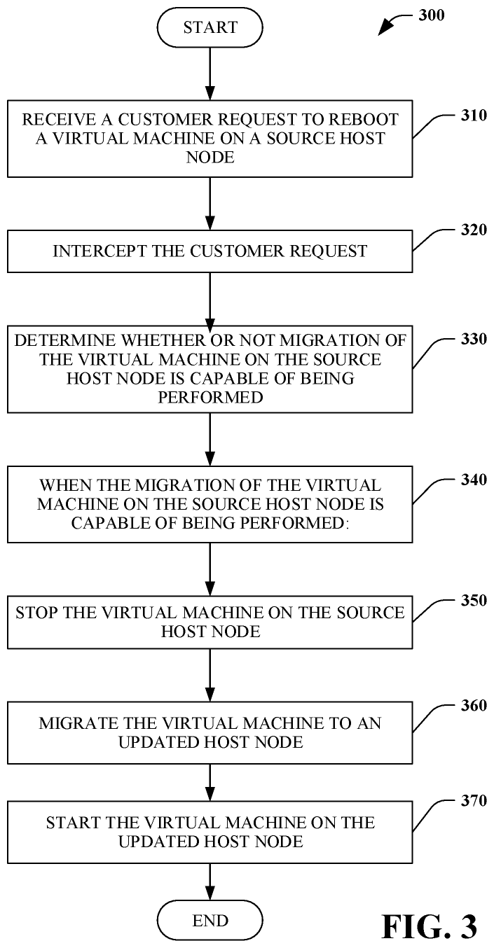

FIGS. 2-3 illustrate exemplary methodologies relating to overlapping migration to another host node. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Turning to FIG. 2, a method of overlapping migration to another host node during a shutdown 200 is illustrated. In some embodiments, the method 200 is performed by the system 100.

At 210, a customer request to shut down a virtual machine on a source host node is received. At 220, the customer request is intercept. At 230, whether or not migration of the virtual machine on the source host node is capable of being performed is determined.

At 240, when the migration of the virtual machine on the source host node is capable of being performed, acts 250, 260, and/or 270 are performed. At 250, the virtual machine on the source host node is stopped. At 260, the virtual machine is migrated to an updated host node. At 270, the virtual machine is shut down on the updated host node.

Next, referring to FIG. 3, a method of overlapping migration to another host node during a reboot 300 is illustrated. In some embodiments, the method 200 is performed by the system 100.

At 310, a customer request to reboot a virtual machine on a source host node is received. At 320, the customer request is intercept. At 330, whether or not migration of the virtual machine on the source host node is capable of being performed is determined.

At 340, when the migration of the virtual machine on the source host node is capable of being performed, acts 350, 360, and/or 370 are performed. At 350, the virtual machine on the source host node is stopped. At 360, the virtual machine is migrated to an updated host node. At 370, the virtual machine is started on the updated host node.

Aspects of the subject disclosure pertain to the technical problem of migrating a host node of virtual machine(s) to an updated host node. The technical features associated with addressing this problem involve receiving a customer request regarding a virtual machine on a source host node. The customer request is intercepted. A determination of whether or not migration of the virtual machine on the source host node is capable of being performed. When the migration of the virtual machine on the source host node is capable of being performed: the virtual machine is stopped on the source host node, and, the virtual machine is migrated to an updated host node. Accordingly, aspects of these technical features exhibit technical effects of more efficiently and effectively overlapping migration of a host node of virtual machine(s) to an updated host node, for example, reducing computer resource(s) and/or bandwidth.

Described herein is a system for overlapping migration to another host node, comprising: a computer comprising a processor and a memory having computer-executable instructions stored thereupon which, when executed by the processor, cause the computer to: receive a customer request regarding a virtual machine on a source host node; intercept the customer request; determine whether migration of the virtual machine on the source host node is capable of being performed; when the migration of the virtual machine on the source host node is capable of being performed: stop the virtual machine on the source host node; and migrate the virtual machine to an updated host node.

The system can further include wherein the customer request is to reboot the virtual machine. The system can include the memory having further computer-executable instructions stored thereupon which, when executed by the processor, cause the computer to: start the virtual machine on the updated host node. The system can further include wherein the customer request is received from a cloud-based service portal.

The system can further include wherein the customer request is received from inside the virtual machine. The system can further include wherein the customer request is to shut down the virtual machine. The system can include the memory having further computer-executable instructions stored thereupon which, when executed by the processor, cause the computer to: shut down the virtual machine on the updated host node.

Described herein is a method of overlapping migration to another host node, comprising: receiving a customer request regarding a virtual machine on a source host node; intercepting the customer request; determining whether migration of the virtual machine on the source host node is capable of being performed; when the migration of the virtual machine on the source host node is capable of being performed: stopping the virtual machine on the source host node; and migrating the virtual machine to an updated host node.

The method can further include wherein the customer request comprises rebooting the virtual machine. The method can further comprise starting the virtual machine on the updated host node. The method can further include wherein the customer request to reboot the virtual machine is received from a cloud-based service portal.

The method can further include wherein the customer request to reboot the virtual machine is received from inside the virtual machine. The method can further include wherein the customer request comprises shutting down the virtual machine. The method can further comprise shutting down the virtual machine on the updated host node.

Described herein is a computer storage medium storing computer-readable instructions that when executed cause a computing device to: receive a customer request regarding a virtual machine on a source host node; intercept the customer request; determine whether migration of the virtual machine on the source host node is capable of being performed; when the migration of the virtual machine on the source host node is capable of being performed: stop the virtual machine on the source host node; and migrate the virtual machine to an updated host node.

The computer storage medium can further include wherein the customer request is to reboot the virtual machine. The computer storage medium can store further computer-readable instructions that when executed cause the computing device to: start the virtual machine on the updated host node. The computer storage medium can further include wherein the customer request to reboot the virtual machine is received from a cloud-based service portal.

The computer storage medium can further include wherein the customer request to reboot the virtual machine is received from inside the virtual machine. The computer storage medium of can further include, wherein the customer request is to shut down the virtual machine, and, the memory having further computer-executable instructions stored thereupon which, when executed by the processor, cause the computer to: shut down the virtual machine on the updated host node.

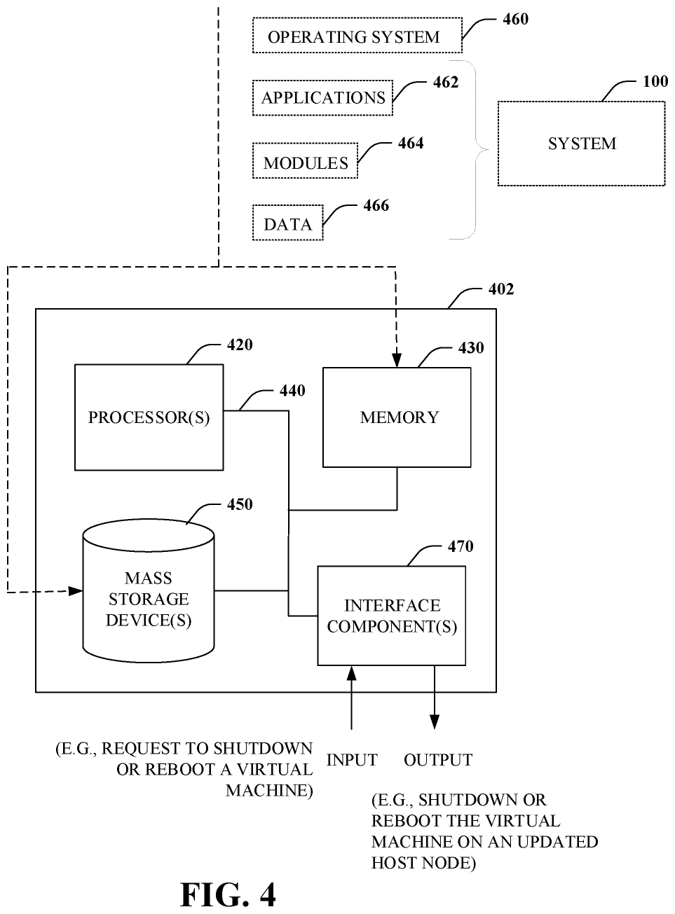

With reference to FIG. 4, illustrated is an example general-purpose computer or computing device 402 (e.g., mobile phone, desktop, laptop, tablet, watch, server, hand-held, programmable consumer or industrial electronics, set-top box, game system, compute node, etc.). For instance, the computing device 402 may be used in a system 100.

The computer 402 includes one or more processor(s) 420, memory 430, system bus 440, mass storage device(s) 450, and one or more interface components 470. The system bus 440 communicatively couples at least the above system constituents. However, it is to be appreciated that in its simplest form the computer 402 can include one or more processors 420 coupled to memory 430 that execute various computer executable actions, instructions, and or components stored in memory 430. The instructions may be, for instance, instructions for implementing functionality described as being carried out by one or more components discussed above or instructions for implementing one or more of the methods described above.

The processor(s) 420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 420 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 420 can be a graphics processor.

The computer 402 can include or otherwise interact with a variety of computer-readable media to facilitate control of the computer 402 to implement one or more aspects of the claimed subject matter. The computer-readable media can be any available media that can be accessed by the computer 402 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 402. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 430 and mass storage device(s) 450 are examples of computer-readable storage media. Depending on the exact configuration and type of computing device, memory 430 may be volatile (e.g., RAM), non-volatile (e.g., ROM, flash memory, etc.) or some combination of the two. By way of example, the basic input/output system (BIOS), including basic routines to transfer information between elements within the computer 402, such as during start-up, can be stored in nonvolatile memory, while volatile memory can act as external cache memory to facilitate processing by the processor(s) 420, among other things.

Mass storage device(s) 450 includes removable/non-removable, volatile/non-volatile computer storage media for storage of large amounts of data relative to the memory 430. For example, mass storage device(s) 450 includes, but is not limited to, one or more devices such as a magnetic or optical disk drive, floppy disk drive, flash memory, solid-state drive, or memory stick.

Memory 430 and mass storage device(s) 450 can include, or have stored therein, operating system 460, one or more applications 462, one or more program modules 464, and data 466. The operating system 460 acts to control and allocate resources of the computer 402. Applications 462 include one or both of system and application software and can exploit management of resources by the operating system 460 through program modules 464 and data 466 stored in memory 430 and/or mass storage device (s) 450 to perform one or more actions. Accordingly, applications 462 can turn a general-purpose computer 402 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 462, and include one or more modules 464 and data 466 stored in memory and/or mass storage device(s) 450 whose functionality can be realized when executed by one or more processor(s) 420.

In some embodiments, the processor(s) 420 can correspond to a system on a chip (SOC) or like architecture including, or in other words integrating, both hardware and software on a single integrated circuit substrate. Here, the processor(s) 420 can include one or more processors as well as memory at least similar to processor(s) 420 and memory 430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 402 also includes one or more interface components 470 that are communicatively coupled to the system bus 440 and facilitate interaction with the computer 402. By way of example, the interface component 470 can be a port (e.g. serial, parallel, PCMCIA, USB, FireWire, etc.) or an interface card (e.g., sound, video, etc.) or the like. In one example implementation, the interface component 470 can be embodied as a user input/output interface to enable a user to enter commands and information into the computer 402, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 470 can be embodied as an output peripheral interface to supply output to displays (e.g., LCD, LED, plasma, etc.), speakers, printers, and/or other computers, among other things. Still further yet, the interface component 470 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for overlapping migration to another host node, comprising:
a computer comprising a processor and a memory having computer-executable instructions stored thereupon which, when executed by the processor, cause the computer to:
receive a customer request regarding a virtual machine on a source host node;
intercept the customer request;
determine whether migration of the virtual machine on the source host node is capable of being performed;
when the migration of the virtual machine on the source host node is capable of being performed:
stop the virtual machine on the source host node; and
migrate the virtual machine to an updated host node.

2. The system of claim 1, wherein the customer request is to reboot the virtual machine.

3. The system of claim 2, the memory having further computer-executable instructions stored thereupon which, when executed by the processor, cause the computer to:
start the virtual machine on the updated host node.

4. The system of claim 2, wherein the customer request is received from a cloud-based service portal.

5. The system of claim 2, wherein the customer request is received from inside the virtual machine.

6. The system of claim 1, wherein the customer request is to shut down the virtual machine.

7. The system of claim 6, the memory having further computer-executable instructions stored thereupon which, when executed by the processor, cause the computer to:
shut down the virtual machine on the updated host node.

8. A method of overlapping migration to another host node, comprising:
receiving a customer request regarding a virtual machine on a source host node;
intercepting the customer request;
determining whether migration of the virtual machine on the source host node is capable of being performed;
when the migration of the virtual machine on the source host node is capable of being performed:
stopping the virtual machine on the source host node; and
migrating the virtual machine to an updated host node.

9. The method of claim 8, wherein the customer request comprises rebooting the virtual machine.

10. The method of claim 9, further comprising:
starting the virtual machine on the updated host node.

11. The method of claim 9, wherein the customer request to reboot the virtual machine is received from a cloud-based service portal.

12. The method of claim 9, wherein the customer request to reboot the virtual machine is received from inside the virtual machine.

13. The method of claim 8, wherein the customer request comprises shutting down the virtual machine.

14. The method of claim 13, further comprising:
shutting down the virtual machine on the updated host node.

15. A computer storage medium storing computer-readable instructions that when executed cause a computing device to:
receive a customer request regarding a virtual machine on a source host node;
intercept the customer request;
determine whether migration of the virtual machine on the source host node is capable of being performed;
when the migration of the virtual machine on the source host node is capable of being performed:
stop the virtual machine on the source host node; and
migrate the virtual machine to an updated host node.

16. The computer storage medium of claim 15, wherein the customer request is to reboot the virtual machine.

17. The computer storage medium of claim 16 storing further computer-readable instructions that when executed cause the computing device to:
start the virtual machine on the updated host node.

18. The computer storage medium of claim 16, wherein the customer request to reboot the virtual machine is received from a cloud-based service portal.

19. The computer storage medium of claim 16, wherein the customer request to reboot the virtual machine is received from inside the virtual machine.

20. The computer storage medium of claim 15, wherein the customer request is to shut down the virtual machine, and, the memory having further computer-executable instructions stored thereupon which, when executed by the processor, cause the computer to:
shut down the virtual machine on the updated host node.
